(19) United States
(12) Patent Application Publication
(10) Pub. No.: US 2014/0215456 A1
(43) Pub. Date: Jul. 31, 2014

(54) METHOD AND APPARATUS FOR MAINTAINING WIRELESS NETWORK DEVICES IN WIRELESS NETWORKS

(71) Applicants: Mathieu Mercier, Laval (CA); Gilbert Moineau, Montreal (CA)

(72) Inventors: Mathieu Mercier, Laval (CA); Gilbert Moineau, Montreal (CA)

(21) Appl. No.: 14/240,363

(22) PCT Filed: Sep. 30, 2011
(86) PCT No.: PCT/US2011/054120

§ 371 Date: Feb. 22, 2014

(51) Int. Cl. G06F 9/445

(52) U.S. Cl. CPC G06F 8/61
USPC 717/175

(57) ABSTRACT

An apparatus for maintaining a wireless network includes an input/output interface (IO) to receive notification of a maintenance package and to communicate with wireless access points of the wireless network, and a controller to communicate with the wireless access points in response to the notification. In a first phase, the controller triggers each of the wireless access points that reaches a state of having no wireless associations to suspend accepting requests for wireless associations and install the maintenance package. In a second phase, the controller triggers each of the wireless access points not having the maintenance package installed after a time period to install the maintenance package.

### BACKGROUND

Computer networks include various devices that facilitate communication between computers, such as routers, switches, firewalls, management appliances, security appliances, and the like (generally referred to as “network devices”). Some network devices include components for communicating wirelessly with the network (“wireless network devices”). Wireless network devices can communicate wirelessly in accordance with various types of protocols, such as protocols defined in the 802.11 standards established by the Institute of Electrical and Electronics Engineers (IEEE).

A network device can include various functions implemented by different components (“network device components”). Some network device components are required to be changed during the life of the network device (e.g., modifying components in the field). For example, a network device can include firmware that is executed or interpreted to implement the various functions performed by the network device. Firmware in a network device can be updated to cause new functionality and/or modify existing functionality. Thus, network devices, including wireless network devices, can include the capability of modifying the implementation of their respective network device components in the field.

### BRIEF DESCRIPTION OF THE DRAWINGS

Some embodiments of the invention are described with respect to the following figures:

FIG. 1 is a block diagram of a wireless network according to an example implementation;

FIG. 2 is a block diagram of a wireless network device according to another example implementation;

FIG. 3 is a flow diagram showing a method of maintaining a wireless network according to an example implementation;

FIG. 4 is a flow diagram showing a method of maintaining a wireless network according to an example implementation; and

FIG. 5 is a flow diagram showing a method of maintaining a wireless network according to an example implementation.

### DETAILED DESCRIPTION

Method and apparatus for maintaining wireless network devices in wireless networks are described. Various approaches can be used to maintain wireless network devices in a wireless network. In one approach, a wireless controller in the wireless network is first upgraded with new firmware. The wireless controller controls several wireless access points. Each wireless access point provides access to the wireless network for wireless stations (e.g., computers, phones, or like type wireless client devices). After the wireless controller is upgraded, wireless access points under control of the wireless controller are upgraded with new firmware simultaneously. Such an approach causes a temporary loss of service for the wireless network. All of the wireless access points are either fetching new firmware or rebooting after having new firmware installed, leaving no wireless access points to provide service to wireless stations. The problem is noticeable to users of the wireless network.

An embodiment of the invention provides for maintaining a wireless network. An input/output (IO) interface receives a maintenance package. A controller is coupled to the IO interface and communicates with the wireless access points in response to the maintenance package. The controller, in a first phase, triggers each of the wireless access points that reaches a state of having no wireless associations to suspend accepting requests for wireless associations and install the maintenance package. Once the maintenance package has been installed, each wireless access point resumes operation and accepts new wireless associations. In a second phase, the controller triggers each of the wireless access points not having the maintenance package installed after a time period to install the maintenance package.

In another embodiment, an IO interface receives notification of the maintenance package, and receives radio frequency (RF) neighborhood data from the wireless access points in the wireless network. A controller is coupled to the IO interface and communicates with the wireless access points in response to the notification and the RF neighborhood data. The controller identifies a common area served by a group of the wireless access points based on the RF neighborhood data. The controller triggers installation of the maintenance package on each wireless access point in the group during a time period such that at least one wireless access point in the group serves the common area throughout the time period. The controller can identify additional common areas and trigger maintenance package installation similarly in such additional common areas.

Even in relatively busy wireless environments, not all of the wireless access points may be in use, and still others may be serving common areas. By selectively installing the maintenance package on wireless access points, the wireless network can be upgraded with relatively little perceived impact to the users of the wireless network. Thus, the wireless network will experience little or no disruption of service provided to users. Various embodiments are described below by referring to several examples.

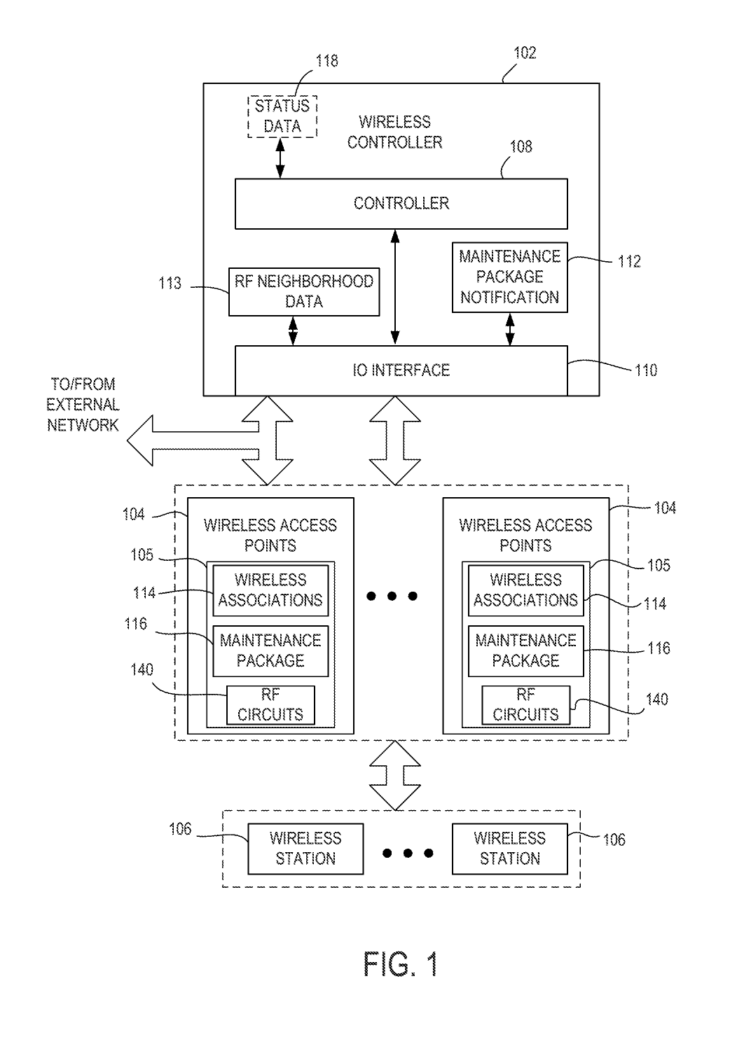

FIG. 1 is a block diagram of a wireless network 100 according to an example implementation. The wireless network 100 includes a wireless controller 102, a plurality of wireless access points (“wireless access points 104”), and a plurality of wireless stations (“wireless stations 106”). The wireless controller 102 is coupled to the wireless access points 104. The wireless controller 102 can be coupled to the wireless access points 104 wirelessly or through a wired-network. The wireless controller 102 controls the wireless access points 104, such as configuring the wireless access points 104, reporting status and statistics of the wireless access points 104, and the like. The wireless controller 102 also maintains the wireless access points 104, as described below.

The wireless access points 104 provide wireless access service the wireless stations 106. The wireless access points 104 can provide wireless access for the wireless stations 106 to an external network, such as a local area network (LAN), wide area network (WAN), or the like, or combination thereof. Each of the wireless access points 104 includes circuits 105 that provide the wireless access service to the wireless stations 106. The circuits 105 can include radio frequency (RF) circuits 140 to communicate with the wireless stations 106 and to perform RF neighborhood scanning, as described below. The wireless stations 106 can be any type of computing device capable of network communication with other devices.

The wireless controller 102 includes a controller 108 and an input/output (IO) interface 110. The IO interface 110 communicates with the wireless access points 104 and an external network. To perform maintenance, the wireless controller 102 receives a maintenance package notification 112 through the IO interface 110 (e.g., from the external network). In some examples, the wireless controller 102 also receives radio frequency (RF) neighborhood data 113 through the IO interface 110 from the wireless access points 104. The maintenance package notification 112 includes an indication that a maintenance package is to be installed on each of the wireless access points. A maintenance package includes data for adding functionality to, and/or modifying functionality of, the wireless access points 104. In an example, a maintenance package includes firmware to replace firmware currently installed in the wireless access points 104 (e.g., a new firmware version). As used herein, “firmware” includes instructions that can be executed by, or interpreted for execution by, a processor (e.g., source code, object code, machine code, etc.). In an example, the maintenance package notification 112 includes a maintenance package 116 that is to be installed on the wireless access points 104. In another example, the maintenance package notification 112 includes a reference to a location to where the maintenance package 116 can be obtained (e.g., a uniform resource locator (URL)).

The RF neighborhood data 113 includes data, for each of the wireless access points, indicating all wireless devices in a neighborhood. Each of the wireless access points 104 can be capable of communicating with wireless devices (e.g., wireless stations 106 and/or other wireless access points 104) in particular neighborhood. Each of the wireless access points 104 can send indications of which wireless stations 106 and/or which of the other wireless access points 104 are in its neighborhood to the wireless controller 102.

The controller 108 is coupled to the 10 interface 110. In an example, the controller 108 initiates maintenance of the wireless access points 104 in response to the maintenance package notification 112. During the maintenance process, the controller 108 communicates with the wireless access points 104 in two phases. In a first phase, the controller 108 triggers each of the wireless access points 104 that reaches a state of having no wireless associations to suspend accepting requests for wireless associations and install the maintenance package 116.

Each of the wireless access points 104 maintains a number of wireless associations 114, which can be zero or more wireless associations. Generally, a wireless association facilitates communication between a wireless access point and a wireless station. In the first phase, when a wireless access point 104 reaches zero wireless associations, the wireless access point 104 stops accepting requests from wireless stations 106 for new wireless associations. Either a wireless access point or a wireless station can break a wireless association. For example, a wireless station can break a wireless association by moving out of range from a wireless access point, being turned off, having its wireless radio turned off, or the like. A wireless access point can terminate a wireless association with a wireless station.

After a wireless access point 104 suspends new wireless associations, the wireless access point 104 installs the maintenance package 116 indicated in the maintenance package notification 112. For example, the maintenance package 116 can include firmware, and a wireless access point can install the maintenance package 116 by performing a firmware update. In general, the maintenance package 116 updates and/or adds functionality of each wireless access point 104.

In the first phase, some number of the wireless access points 104 may have previously had zero wireless associations 114. Such wireless access points 104 can initiate maintenance by obtaining a maintenance package 116. In an example, those of the wireless access points 104 that have zero wireless associations can install the maintenance package contemporaneously. In another example, discussed below, the wireless access points 104 can install the maintenance package in a more selective manner based on common areas of service.

In an example, the maintenance package notification 112 includes a maintenance package 116, and the wireless controller 102 can provide a maintenance package 116 to any of the wireless access points 104. In another example, the maintenance package notification 112 includes a reference to the maintenance package 116, and the wireless controller 102 can provide the reference to any of the wireless access points 104. Upon receiving a reference, a wireless access point can obtain the maintenance package 116.

In an example, the controller 108 actively triggers installation of the maintenance package on the wireless access points 104. For example, the IO interface 110 can receive notification data from each of the wireless access points that have zero wireless associations. The notification data can be received from the wireless access points 104 throughout the first phase. The controller 108 can actively trigger installation of the maintenance package on each of the wireless access points 104 that notifies as having zero wireless associations.

In another example, the controller 108 can allow autonomous installation of the maintenance package. For example, the controller 108 can command each of the wireless access points 104 to install the maintenance package if and when they have zero wireless associations. The wireless access points 104 can then request the maintenance package from the controller 108 or fetch the maintenance package from some other source based on a reference.

The controller 108 can perform the first phase for some time period. During the first phase, some number of the wireless access points 104 may persist in having at least one wireless association 114 such that the maintenance package is not installed. In an example, the controller 108 can wait for a particular time period for each of the wireless access points 104 to reach zero wireless associations 114 during the first phase. For any of the wireless access points 104 that reach zero wireless associations during the time period, the controller 108 provides the install command thereto causing installation of the maintenance package 116.

After the time period expires, the controller 108 can initiate a second phase. In the second phase, the controller triggers each of the wireless access points not having the maintenance package installed to install the maintenance package. In some cases, all of the wireless access points 104 may have had the maintenance package 116 installed during the first phase. Hence, the controller 108 may not have to initiate the second phase. In an example, during the second phase, the controller 108 causes the wireless access points to install the maintenance package successively one-by-one after a delay period (e.g., in serial). The delay period can be a reboot time of a wireless access point.

In another example, the controller 108 can use the RE neighborhood data 113 to cause selective updating of the wireless access points 104 during the first and/or the second phase. As noted above, each of the wireless access points 104 has a neighborhood in which wireless devices can be served. In some cases, neighborhoods of two or more of the wireless access points 104 can overlap, resulting in “common areas.” A common area can be defined such that each wireless access point in a group of wireless access points (e.g., two or more wireless access points) can access each other or a common wireless station 106. A wireless station 106 located in a common area can be served by a plurality of the wireless access points 104. During the first and/or second phase, the controller 108 can identify common areas served by groups of the wireless access points based on the RE neighborhood data 113. The controller 108 can then trigger installation of the maintenance package on each wireless access point in a group such that the common area is continuously served by at least one wireless access point in the group. For example, the controller 108 can trigger installation of the maintenance package successively so that not all of the wireless access points serving the common area are updated at the same time. Thus, each wireless station 106 in a common area will be able to communicate with at least one of the wireless access points 104 during the update.

In an example, each of the common areas can have different weights based on the amount of service overlap. Higher weights can be given to common areas with more service overlap, and lower weights given to common areas with less service overlap. For example, one type of common area can exist where multiple wireless access points 104 can see each other in addition to some of the wireless stations 106. Such a common area can be assigned a higher weight due to the large service overlap. Another type of common area can exist where two wireless access points 104 can see a common wireless station 106, but not each other. Such a common area can be assigned a lower weight due to the smaller service overlap. In an example, the controller 108 can selectively installation of the maintenance package in common areas based on a weight threshold. In such an example, for common areas that have low service overlap (and thus lower weight value), the controller 108 will not trigger installation of the maintenance package to any of the wireless access points 104 in that common area that have at least one wireless association.

In an example, the wireless controller 102 can maintain status data 118 indicative of the state of wireless associations 114 on each of the wireless access points 104. The status data 118 can be derived from the RF neighborhood data 113 and or derived from notifications received from the wireless access points 104. The wireless controller 102 can store the status data 118 in a memory or like type storage device (an example described below). The controller 108 can use the status data 118 to determine when to trigger installation of the maintenance package on the wireless access points 104. From the status data, the controller 108 can identify each of the wireless access points 104 having zero wireless associations 114 during the time period. From the status data, the controller 108 can also identify wireless access points serving common areas and, optionally, determine weights for the common areas.

In another example, the controller 108 does not perform the two phase maintenance process discussed above based. Rather, the controller 108 performs a selected maintenance process based on common areas identified from the RF neighborhood data 113 regardless of the number of wireless associations the wireless access points 104 have. For example, in response to the RF neighborhood data 113, the controller 108 can identify common areas for groups of the wireless access points 104, as discussed above. The controller 108 can then trigger installation of the maintenance package on each wireless access point in a group during a time period such that at least one wireless access point in the group serves the common area throughout the time period. The controller 108 can trigger installation of the maintenance package in this manner for each of the common areas. Since in any given common area there will always be at least one wireless access point active, the wireless stations will not experience a service disruption. After some time, all of the wireless access points will have the maintenance package installed.

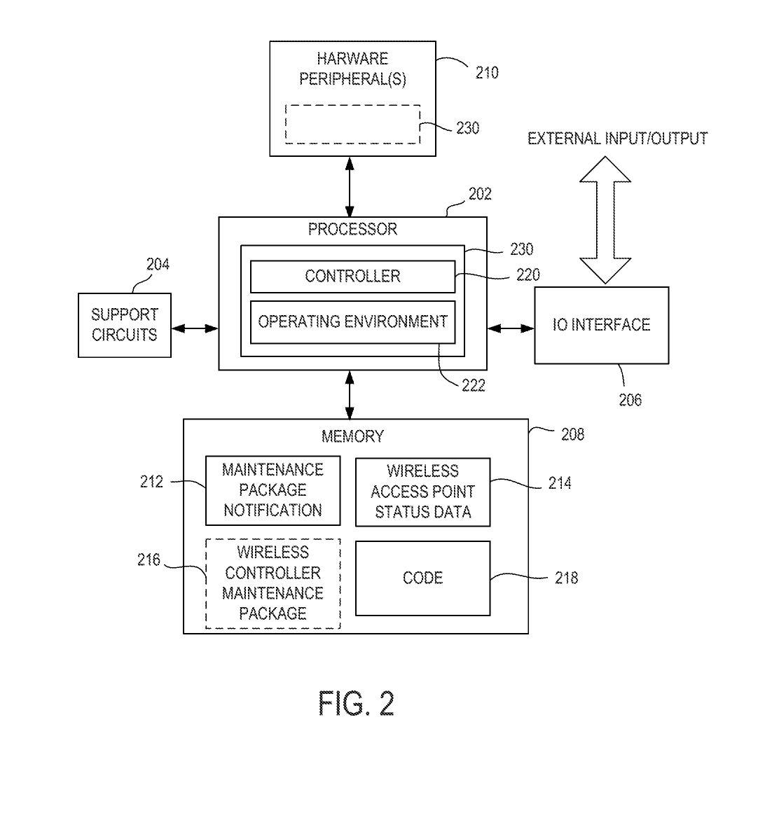

FIG. 2 is a block diagram of a wireless network device 200 according to another example implementation. The wireless network device 200 includes a processor 202, support circuits 204, an IO interface 206, a memory 208, and hardware peripheral(s) 210. The processor 202 includes any type of microprocessor known in the art. The support circuits 204 for the processor can include cache, power supplies, clock circuits, data registers, IO circuits, radio circuits, and the like. The IO interface 206 can be directly coupled to the memory 208, or coupled to the memory 208 through the processor 202. The IO interface 206 can receive external input applied to the wireless network device 200. The memory 208 can include random access memory, read only memory, cache memory, magnetic read/write memory, or the like or any combination of such memory devices. The hardware peripheral(s) 210 can include various hardware circuits that perform functions on behalf of the processor 202 and the wireless network device 200.

The memory 208 stores data for the wireless network device 200, including a maintenance package notification 212 and wireless access point status data 214. In examples, the memory 208 also stores a wireless controller maintenance package 216 and code 218.

In an example, the processor 202 implements a controller 220 and an operating environment 222 to provide the functions described below. The memory 208 can store code 218 that is executed by, or interpreted for execution by, the processor 202 to implement the controller 220 and the operating environment 222. For example, the code 218 may include firmware for the wireless network device 200. In an example, the controller 220 and the operating environment 222 are part of a component group 230 implemented by the processor 202. In some examples, the controller 220 and/or the operating environment 222 can be implemented as a dedicated circuit on the hardware peripheral(s) 210. For example, the hardware peripheral(s) 210 can include a programmable logic device (PLD), such as a field programmable gate array (FPGA), which can be programmed to implement the functions of the controller 220 and/or the operating environment 222. The component group 230 can be implemented as a combination of a processor executing code and dedicated circuitry in hardware peripheral(s).

The maintenance package notification 212 includes an indication that a maintenance package is to be installed on wireless access points under control of the wireless network device 200. A maintenance package includes data for adding functionality to, and/or modifying functionality of, wireless access points. In an example, a maintenance package includes firmware to replace firmware currently installed in wireless access points (e.g., a new firmware version). In an example, the maintenance package notification 212 includes a maintenance package that is to be installed on wireless access points. In another example, the maintenance package notification 212 includes a reference to a location to where a maintenance package can be obtained (e.g., a uniform resource locator (URL)).

In an example, the wireless access point status data 214 indicates of the state of wireless associations on wireless access points under control of the wireless network device 200 (e.g., a number of wireless associates each wireless access point current maintains). The controller 220 can use the wireless access point status data 214 to perform maintenance on wireless access points, as described below.

The controller 220 obtains the maintenance package notification 212 as parametric input. The maintenance package notification 212 can be received from an external network through the 10 interface 206. In an example, the maintenance package notification 212 is received along with the wireless controller maintenance package 216. The wireless controller maintenance package 216 can include data for updating and/or adding functionality to the wireless network device 200. For example, the wireless controller maintenance package 216 can include code for replacing all or a portion of the code 218 (e.g., a firmware upgrade). If present, the controller 220 can also receive the wireless controller maintenance package 216 as parametric input.

The controller 220 initiates maintenance of wireless access points in response to the maintenance package notification 212. The controller 220 communicates with the wireless access points through the 10 interface 206. In an example, the controller 220 initiates a two-phase process. In the first phase, the controller 220 triggers installation of the maintenance package to wireless access points that reach zero wireless associations. In a second phase, the controller 220 triggers installation of the maintenance package to any remaining wireless access points that have not had the maintenance package installed. In another example, the controller 220 selectively triggers installation of the maintenance package on the wireless access points based on identification of common areas. Groups of wireless access points are updated such that service is not disrupted in the common areas, as discussed above. In an example, the controller 220 can send the maintenance package to the targeted wireless access points through the 10 interface 206. In another example, the controller 220 sends a reference to the targeted wireless access points through the IO interface 206 that indicates where the maintenance package can be obtained. When a wireless access point installs the maintenance package, the operating environment thereof is modified (e.g., a firmware update).

If the wireless network device 200 receives the wireless controller maintenance package 216, the controller 220 can issue another command targeted to the wireless network device 200. The other command can modify the operating environment 222 with the wireless controller maintenance package 216. The operating environment 222 implements various functions of the wireless network device 200 for controlling wireless access points. The operating environment 222 can be modified by modifying all or a portion of the code with the wireless controller maintenance package 216. In an example, the controller 220 issues the other command prior to any of the first through third commands described above. Thus, the controller 220 can cause an update of the wireless network device 200 prior to updating wireless access points.

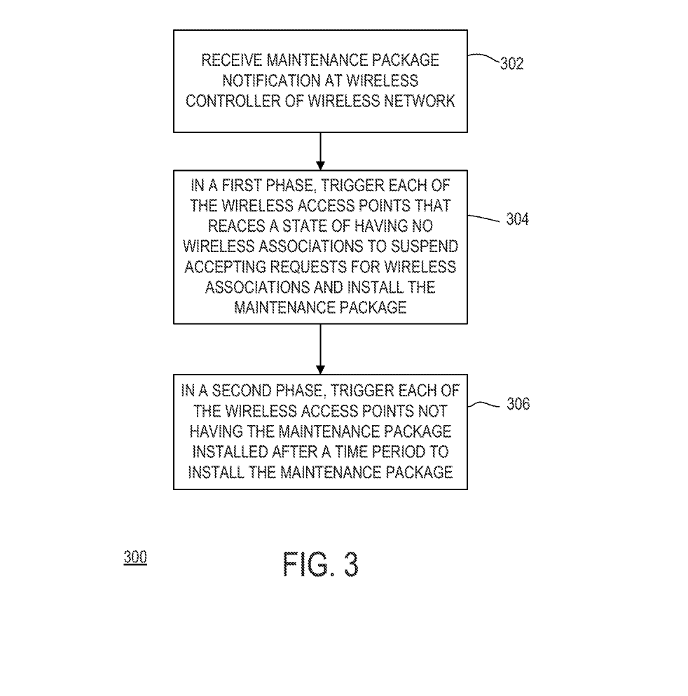

FIG. 3 is a flow diagram showing a method 300 of maintaining a wireless network according to an example implementation. The method 300 begins at step 302, where a maintenance package notification is received at a wireless controller of a wireless network. At step 304, in a first phase, each of the wireless access points that reaches a state of having no wireless associations is triggered to suspend accepting requests for wireless associations and install the maintenance package.

At step 306, after a time period and in a second phase, each wireless access point not having the maintenance package installed is triggered to install the maintenance package. In an example, at step 306, each of the wireless access points not having the maintenance package installed is triggered to install the maintenance package successively one-by one after a delay period. In an example, the delay period can be a reboot time of a wireless access point. A reboot time can be the time that a wireless access point takes to become operational after being rebooted.

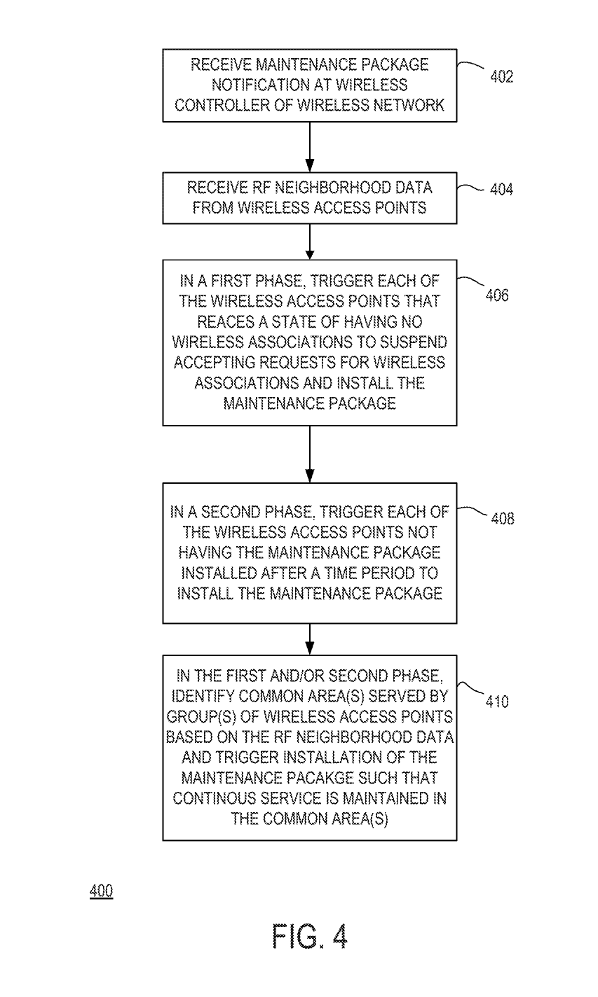

FIG. 4 is a flow diagram showing a method 400 of maintaining a wireless network according to an example implementation. The method 400 begins at step 402, where a maintenance package notification is received at a wireless controller of a wireless network. At step 404, RF neighborhood data is received from the wireless access points. At step 406, in a first phase, each of the wireless access points that reaches a state of having no wireless associations is triggered to suspend accepting requests for wireless associations and install the maintenance package At step 408, after a time period and in a second phase, each wireless access point not having the maintenance package installed is triggered to install the maintenance package. At step 410, in the first and/or the second phase, identify common area(s) served by group(s) of the wireless access points based on the RF neighborhood data and trigger installation of the maintenance package such that continuous service is maintained in the common area(s).

Thus, if two wireless access points service a common area and both reach zero associations in the first phase, then the wireless access points can be updated successively such that the common area is always supported by one wireless access point. If two wireless access points service a common area and one or both have wireless associations in the second phase, then the wireless access points can be updated successively such that service in the common area is maintained for the wireless station(s).

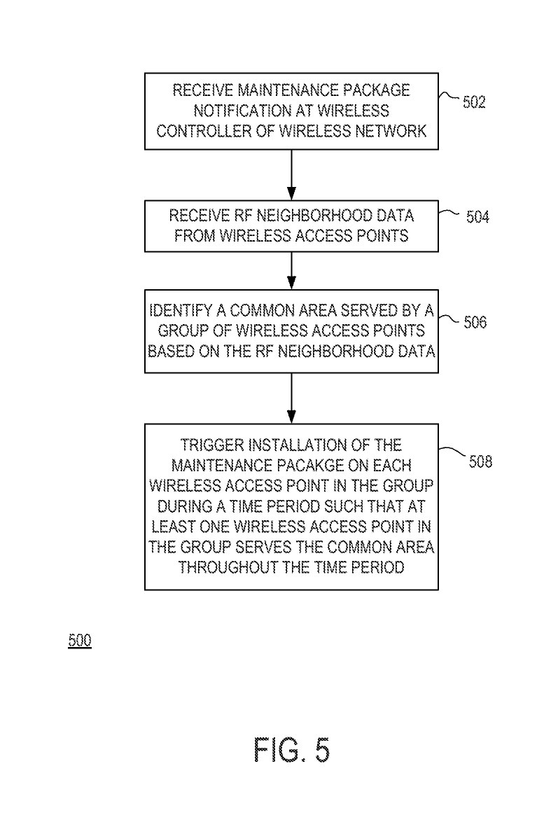

FIG. 5 is a flow diagram showing a method 500 of maintaining a wireless network according to an example implementation. The method 500 begins at step 502, where notification of a maintenance package is received at a wireless controller. At step 504, RF neighborhood data is received from wireless access points under control of the wireless controller. At step 506, a common area is identified that is served by a group of the wireless access points based on the RF neighborhood data. Step 506 can be repeated to identify multiple common areas served by different groups of the wireless access points. At step 508, installation of the maintenance package is triggered on each wireless access point in the group during a time period such that at least one wireless access point in the group serves the common area throughout the time period. Step 508 can be repeated for each identified common area.

Method and apparatus for maintaining wireless network devices in wireless networks have been described. Maintenance of a wireless access point can require a wireless access point to be rebooted, which temporarily prevents the wireless access point from providing service. If all of the wireless access points are maintained at the same time, then there will be a loss of service in the wireless network. In various example implementations described above, a wireless controller in a wireless network attempts to maintain wireless access points under its control only when each wireless access point provides no actual service to wireless stations or redundant service to wireless stations. In this manner, service disruption in the wireless network is minimized or eliminated. Further, even in relatively busy wireless environments, it is not likely that all of the wireless access points are used all of the time. Thus, the wireless controller in the example implementations above can initiate maintenance on all of the wireless access points under its control, which avoids the complexity of dividing the wireless access points into subsets and only maintaining the subsets one at a time.

The methods described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc., just to name a few. Other new and various types of computer-readable media may be used to store machine readable code discussed herein.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. An apparatus to maintain a wireless network, comprising:
an input/output (IO) interface to receive notification of a maintenance package; and
a controller, coupled to the IO interface, to communicate with the wireless access points in response to the notification to:
in a first phase, trigger each of the wireless access points that reaches a state of having no wireless associations to suspend accepting requests for wireless associations and install the maintenance package; and
in a second phase, trigger each of the wireless access points not having the maintenance package installed after a time period to install the maintenance package.

2. The apparatus of claim 1, wherein the IO interface receives radio frequency (RF) neighborhood data from the wireless access points, and wherein the controller, during at least one of the first or second phases, identifies a common area served by a group of the wireless access points based on the RF neighborhood data, and triggers installation of the maintenance package on each wireless access point in the group such that common area is continuously served by at least one wireless access point in the group.

3. The apparatus of claim 1, wherein the controller, in the second phase, triggers each of the wireless access points not having the maintenance package installed after the time period successively one-by-one after a delay period.

4. The apparatus of claim 1, wherein the IO interface receives notification data from each of the wireless access points that have no wireless associations and wherein the controller, during the first phase, actively triggers installation of the maintenance package based on the notifications.

5. The apparatus of claim 1, wherein the controller, during the first phase, allows autonomous installation of the maintenance package on each of the wireless access points that have no wireless associations.

6. An apparatus to maintain a wireless network, comprising:
an input/output (IO) interface to receive notification of a maintenance package and to communicate with wireless access points of the wireless network to receive radio frequency (RF) neighborhood data; and
a controller, coupled to the IO interface, to communicate with the wireless access points in response to the notification and the RF neighborhood data to:
identify a common area served by a group of the wireless access points based on the RF neighborhood data; and
trigger installation of the maintenance package on each wireless access point in the group during a time period such that at least one wireless access point in the group serves the common area throughout the time period.

7. The apparatus of claim 6, wherein the common area is defined such that each wireless access point in the group can access each other or a common wireless client station.

8. The apparatus of claim 6, wherein the controller triggers installation of the maintenance package on each wireless access point in the group successively one after another.

9. The apparatus of claim 6, wherein the controller triggers each of the wireless access points not having the maintenance package install after an expiration time period to install the maintenance package.

10. The apparatus of claim 9, wherein the controller triggers each of the wireless access points not having the maintenance package installed after the expiration time period successively one after another.

11. A method of maintaining a wireless network, comprising:
receiving notification of a maintenance package at a wireless controller of the wireless network that controls wireless access points;
triggering, in a first phase, each of the wireless access points that reaches a state of having no wireless associations to suspend accepting requests for wireless associations and install the maintenance package; and
triggering, in a second phase, each of the wireless access points not having the maintenance package installed after a time period to install the maintenance package.

12. The method of claim 11, further comprising:
receiving radio frequency (RF) neighborhood data from the wireless access points at the wireless controller;
identifying a common area served by a group of the wireless access points based on the RF neighborhood data; and
during at least one of the first or second phases, triggering installation of the maintenance package on each wireless access point in the group such that the common area is continuously served by at least one wireless access point in the group.

13. The method of claim 11, further comprising:
receiving notification data from each of the wireless access points that have no wireless associations at the wireless controller;
during the first phase, actively triggering installation of the maintenance package based on the notifications.

14. The method of claim 11, further comprising:
during the first phase, allowing autonomous installation of the maintenance package on each of the wireless access points that have no wireless associations.

15. The method of claim 11, further comprising:
installing another maintenance package on the wireless controller prior to the steps of triggering.

16. A method of maintaining a wireless network, comprising:
receiving notification of a maintenance package at a wireless controller of the wireless network;
receiving radio frequency (RF) neighborhood data from wireless access points under control of the wireless controller in the wireless network;
identifying a common area served by a group of the wireless access points based on the RF neighborhood data; and
triggering installation of the maintenance package on each wireless access point in the group during a time period such that at least one wireless access point in the group serves the common area throughout the time period.

17. The method of claim 16, wherein the common area is defined such that each wireless access point in the group can access each other or a common wireless client station.

18. The method of claim 16, wherein the maintenance package is installed on each wireless access point in the group successively one after another.

19. The method of claim 16, wherein each of the wireless access points not having the maintenance package are triggered to install the maintenance package after an expiration time period.
